(19) United States
(12) Patent Application Publication
(10) Pub. No.: US 2018/0257436 A1
(43) Pub. Date: Sep. 13, 2018

(54) PNEUMATIC VEHICLE TIRE

(71) Applicant: Continental Reifen Deutschland GmbH, Hannover (DE)

(72) Inventors: Michal Lacko, Puchov (SK); Matthias Gehlauf, Sehnde (DE); Peter Lacko, Puchov (SK)

(21) Appl. No.: 15/979,007

(22) Filed: May 14, 2018

Related U.S. Application Data
(63) Continuation of application No. PCT/EP2016/068961, filed on Aug. 9, 2016.

(30) Foreign Application Priority Data
Nov. 13, 2015 (DE) 102015222447.3

(51) Int. Cl. B60C 9/20

(52) U.S. Cl. CPC B60C 9/2006; B60C 2200/06; B60C 2009/2019

(57) ABSTRACT

A pneumatic vehicle tire for utility vehicles includes a carcass, a profiled tread and a belt formed from at least four belt plies arranged lying one on top of the other. The belt plies are formed with parallel strength members embedded in rubber. The second belt ply and the third belt ply are working plies. The strength members of the second belt ply have an opposite axial direction of inclination in relation to those of the third belt ply. The strength members of the first belt ply and the strength members of the third belt ply and the strength members of the fourth belt ply are oriented in the tire with the same axial direction of inclination.

### CROSS REFERENCE TO RELATED APPLICATIONS

This application is a continuation application of international patent application PCT/EP2016/068961, filed Aug. 9, 2016 designating the United States and claiming priority from German application 10 2015 222 447.3, filed Nov. 13, 2015, and the entire content of both applications is incorporated herein by reference.

### FIELD OF THE INVENTION

The invention relates to a pneumatic vehicle tire for utility vehicles, having a carcass, having a belt which is constructed radially outside the carcass and having a profiled tread which is constructed on the belt radially outside the belt, wherein the belt is formed from at least four belt plies arranged lying one on top of the other from the radial inside to the radial outside, wherein the first belt ply, which is arranged furthest to the inside in the radial direction R, is formed with parallel strength members embedded in rubber, the second belt ply, arranged on the first belt ply, is formed with parallel strength members embedded in rubber, the third belt ply, arranged on the second belt ply, is formed with parallel strength members embedded in rubber, and the fourth belt ply, arranged on the third belt ply, is formed with parallel strength members embedded in rubber, wherein the second belt ply and the third belt ply are working plies, in which the strength members of the second belt ply enclose, in terms of their orientation, an angle a with the circumferential direction U, where 10°<α<45°, and the strength members of the third belt ply each enclose, in terms of their orientation, an angle γ with the circumferential direction U, where 10°γ≤45°, wherein, as viewed in the circumferential direction U of the vehicle tire, the strength members of the second belt ply have an opposite axial direction of inclination in relation to the strength members of the third belt ply, and wherein the strength members of the first belt ply enclose, in terms of their orientation, an angle β with the circumferential direction U, where 46°≤β≤54°.

### BACKGROUND OF THE INVENTION

It is known that the configuration of the belt structure has a significant influence on the wear pattern of utility vehicle tires. It is for example conventional to use a so-called rhombic belt with typically four layers, the steel cords of which enclose an angle of 16° to 20° with the circumferential direction of the tire, and the plies are laid such that the steel cords cross one another in alternating fashion. A further typical belt for utility vehicle tires is the so-called triangular belt with four plies, wherein the steel cords in the first, radially innermost belt ply enclose an angle of 50° to 65° with the circumferential direction. It is furthermore conventional for the orientation of the steel cords in the individual belt plies with respect to the circumferential direction to be denoted by R for a rightward inclination and by L for a leftward inclination. A typical sequence of such utility vehicle tires is RRLL with an angle of for example 50° in the first (radially innermost) belt ply and an angle of in each case 18° in the other belt plies.

DE 10 2006 020 933 A1 has disclosed a belt in which the strength members of the first, radially innermost belt ply enclose an angle of 50° to 65° with the circumferential direction. The second and third belt plies have strength members which enclose in each case an identical angle of 16° to 20° with the circumferential direction. The fourth belt ply has a very large angle with the circumferential direction, and amounts to between 50° and 90°, preferably between 70° and 90°. The sequence of the arrangement of the strength members from the first to the fourth belt ply is RRLR. By means of this specific belt orientation, it can be achieved that the shoulder wear is reduced.

United States patent application publication 2014/0238573 A1 has disclosed a configuration of a utility vehicle tire with four belt plies, in the case of which the strength members of the first, radially innermost belt ply and the strength members of the fourth, radially outermost belt ply are configured with an angle of between 40° and 55° with the circumferential direction and the strength members of the second and third belt plies are configured so as to enclose an angle of 10° and 30° with the circumferential direction. The sequence of the arrangement of the strength members from the first to the fourth belt ply is RRLL. This configuration makes it possible to further reduce the disproportionately high wear in the shoulder region and thus further homogenize the wear pattern of the tire as a whole.

### SUMMARY OF THE INVENTION

It is an object to provide a utility vehicle tire with a belt with four belt plies, wherein the wear rate of the tire as a whole can be reduced without impairing the wear pattern.

The object can, for example, be achieved via an embodiment of a pneumatic vehicle tire for utility vehicles, having a carcass, having a belt which is constructed radially outside the carcass and having a profiled tread which is constructed on the belt radially outside the belt, wherein the belt is formed from at least four belt plies arranged lying one on top of the other from the radial inside to the radial outside, wherein the first belt ply, which is arranged furthest to the inside in the radial direction R, is formed with parallel strength members embedded in rubber, the second belt ply, arranged on the first belt ply, is formed with parallel strength members embedded in rubber, the third belt ply, arranged on the second belt ply, is formed with parallel strength members embedded in rubber, and the fourth belt ply, arranged on the third belt ply, is formed with parallel strength members embedded in rubber, wherein the second belt ply and the third belt ply are working plies, in which the strength members of the second belt ply enclose, in terms of their orientation, an angle a with the circumferential direction U, where 10°≤α≤45°, and the strength members of the third belt ply each enclose, in terms of their orientation, an angle γ with the circumferential direction U, where 10°≤γ≤45°, wherein, as viewed in the circumferential direction U of the vehicle tire, the strength members of the second belt ply have an opposite axial direction of inclination in relation to the strength members of the third belt ply, and wherein the strength members of the first belt ply enclose, in terms of their orientation, an angle β with the circumferential direction U, where 46°≤β≤54°, wherein the strength members of the fourth belt ply enclose, in terms of their orientation, an angle ϵ with the circumferential direction U, where 46°≤ϵ≤54°, and wherein the strength members of the first belt ply and the strength members of the third belt ply and the strength members of the fourth belt ply are oriented in the tire with the same axial direction of inclination.

It has been found that utility vehicle tires with such a configuration exhibit a considerably improved wear rate despite a good wear pattern. This presumably lies in the fact that the opposite orientation of the first and second belt plies in the belt assembly gives rise to a greater stiffness in the circumferential direction.

In an embodiment of a pneumatic vehicle tire, the angle a with the circumferential direction U is configured such that 15≤α≤30°—in particular α=18°—and the angle γ with the circumferential direction U is configured such that 15°≤γ≤30°—in particular γ=18°. This configuration permits a particularly good compromise between high circumferential stiffness and high transverse stiffness of the belt assembly.

In an embodiment of a pneumatic vehicle tire, the angle β with the circumferential direction U is configured such that β=50° is advantageous. It has been found that utility vehicle tires with specifically such a configuration exhibit a further improved wear rate despite a good wear pattern. This presumably lies in the fact that further increased lateral stiffness is additionally realized in this way.

In an embodiment of a pneumatic vehicle tire, the angle β with the circumferential direction U is configured such that β=50°. The wear pattern can be further optimized in this way.

In an embodiment of a pneumatic vehicle tire, the inclination of the strength members of the four belt plies with respect to the circumferential direction U follows a sequence LRLL from the first belt ply to the fourth belt ply, wherein L means leftward ascent and R means rightward ascent. It has been found that, via this configuration, the wear rate during normal road usage can be further optimized.

In an embodiment of a pneumatic vehicle tire, the strength members of the four belt plies are steel cords. In this way, a good connection of rubber material of the belt to the strength members in the vulcanization process is promoted, with a high strength of the strength members being utilized, and with little outlay.

In an embodiment of a pneumatic vehicle tire, the second belt ply is formed so as to be larger, in terms of its axial extent in the pneumatic vehicle tire, than all of the other belt plies of the belt. In this way, the shear forces generated in the region of the tire shoulder between the second and third belt plies can be further reduced.

In an embodiment of a pneumatic vehicle tire, the third belt ply is formed so as to be larger, in terms of its axial extent in the pneumatic vehicle tire, than the first and the fourth belt plies. This permits a particularly uniform stiffness distribution in the second belt ply.

In an embodiment of a pneumatic vehicle tire, the strength members of the two working plies in the tire are configured to be extensible, with an elongation D of D≥0.2% at 10% of the breaking force. This configuration permits improved producibility. Furthermore, in this way, it is made possible to easily realize a belt assembly which is particularly resistant to puncturing or piercing.

### BRIEF DESCRIPTION OF THE DRAWINGS

The invention will now be described with reference to the drawings wherein:

FIG. 1 shows the cross-sectional illustration of a pneumatic vehicle tire for utility vehicles of radial type of construction; and,

FIG. 2 shows a plan view of the belt from FIG. 1 as per the section II-II in FIG. 1, wherein for simplicity, all of the other components of the tire have not been illustrated.

### DESCRIPTION OF THE PREFERRED EMBODIMENTS OF THE INVENTION

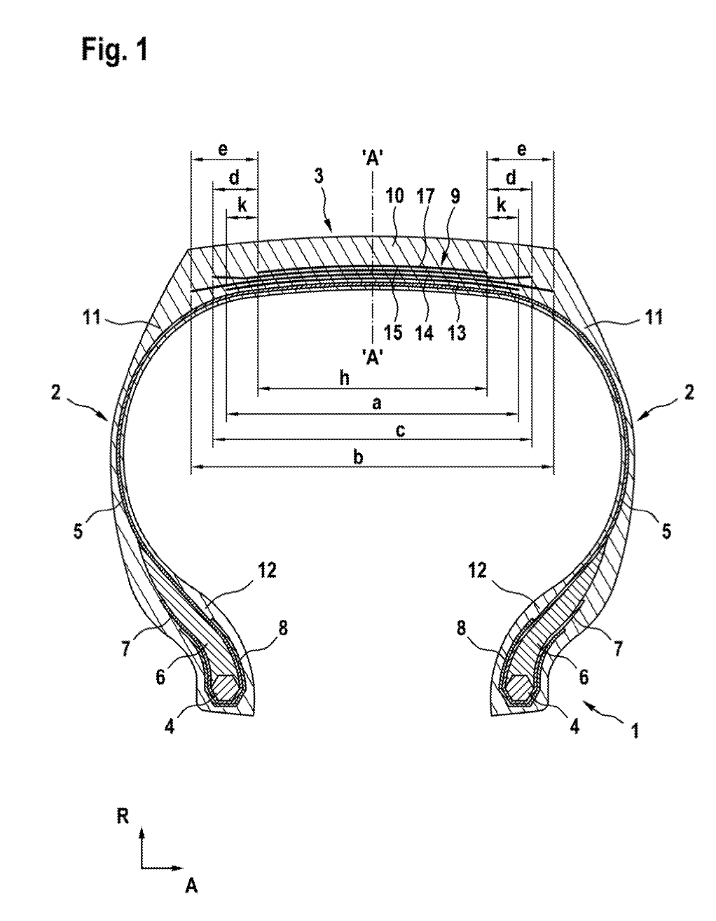

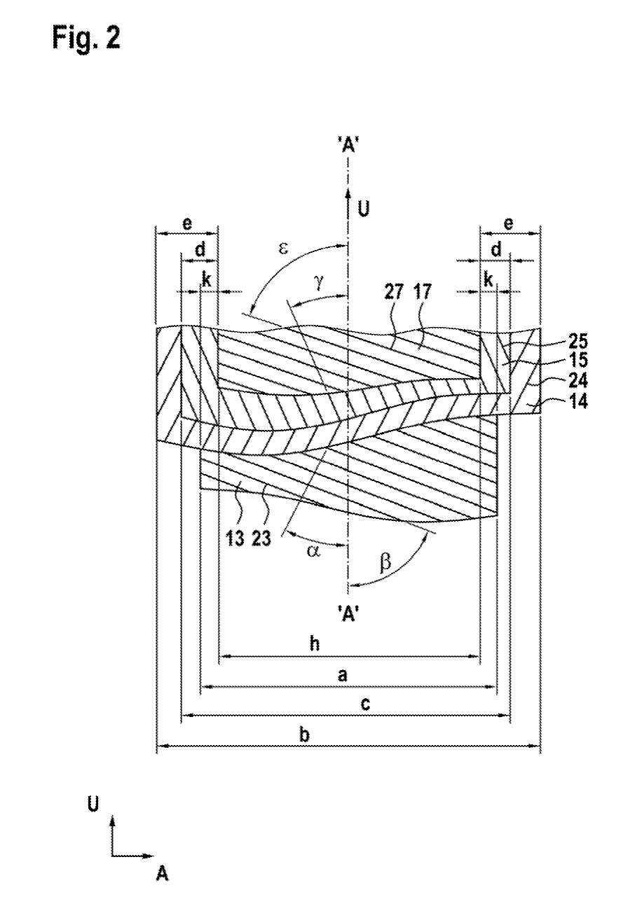

FIG. 1 and FIG. 2 show a pneumatic tire of radial type of construction for utility vehicles, having two side walls 2 which extend in the radial direction R of the vehicle tire and having a crown region (head region) 3 which is formed axially between the side walls. The side walls 2 are each formed with a bead region 1 on their extent end pointing inward in the radial direction, in which bead region there is formed a bead core 4 of known type, which has high tensile strength in the circumferential direction U and which extends over the circumference of the tire in the circumferential direction. The bead cores 4 are, in a known manner, formed in a wound manner from wire which extends in the circumferential direction U of the pneumatic vehicle tire and which is embedded in rubber. In the conventional manner, an apex (bead filler) 6 which is triangular in cross section is formed from a hard rubber material on the bead cores 4. The pneumatic vehicle tire is formed with a carcass 5 which, starting from the bead core 4 formed in the left-hand bead region 1 of the pneumatic vehicle tire, extends outward in the radial direction R of the pneumatic vehicle tire through the left-hand side wall 2 as far as the crown region 3, and in the crown region 3 extends in the axial direction A of the pneumatic vehicle tire to the right-hand side wall 2, and in the right-hand side wall 2 of the pneumatic vehicle tire extends radially inward as far as the bead core 4 formed in the bead region 1 of the right-hand side wall 2. The carcass 5 is, in both bead regions 1, formed so as to extend radially outward in each case along the axial inner side of the bead core 4 to the radial inner side of the respective bead core 4, then as an extension in the axial direction A along the radial inner side of the bead core 4 to the axial outer side of the bead core 4, and then as an extension on the axial outer side of the bead core 4, so as to constitute a turned-over part 7. The carcass 5 extends with its turned-over part 7 along the axial outer side of the apex 6 and ends on the axial outer side of the apex 6. The carcass 5 is formed, in a way which is known but not illustrated in more detail, from a carcass ply which extends in the circumferential direction U over the entire circumference of the pneumatic vehicle tire and which has parallel cords—for example steel cords—which are embedded in rubber and extend substantially in the radial direction R in the region of the side walls 2 and substantially in the axial direction A in the crown region. An inner layer 12 made of known, particularly air-impermeable rubber material extends from the left-hand bead region 1 as far as the right-hand bead region 1 on that side of the carcass 5 which points toward the inside of the tire. An additional bead reinforcing strip 8, which extends over the entire circumference of the pneumatic vehicle tire, is respectively formed in the bead region 1 on that side of the carcass 5 which points away from the bead core 4. The bead reinforcing strip 8 is, for example, a material strip which is embedded in rubber and includes parallel strength members of a textile or metallic configuration.

In the region of the tire crown (of the tire head) 3, a belt 9, which extends over the entire circumference of the pneumatic vehicle tire in the circumferential direction U and in the axial direction A from the left-hand tire shoulder as far as the right-hand tire shoulder, is formed on the carcass 5, outside the carcass 5 in the radial direction R of the pneumatic vehicle tire, which belt 9 is formed from four belt plies 13, 14, 15 and 17 which are arranged one above the other and so as to lie one on top of the other in the radial direction R from the inside to the outside. A profiled tread 10 of a known configuration, which extends over the entire circumference of the pneumatic vehicle tire in the circumferential direction U and in the axial direction A from the left-hand tire shoulder as far as the right-hand tire shoulder and which completely covers the belt 9, is formed on the belt 9 radially outside the belt 9. In the region of the tire side walls 2, a side wall rubber strip 11, which extends in the radial direction R from the bead region 1 as far as the profiled tread 10 in the crown region 3, is formed in a known manner on that side of the carcass 5 which points away axially from the tire.

That belt ply 13 of the belt which is arranged furthest to the inside in the radial direction R forms the first belt ply 13. That belt ply 14 which is arranged on the first belt ply 13, outside the first belt ply 13 in the radial direction R, forms the second belt ply 14. That belt ply 15 which is arranged on the second belt ply 14, outside the second belt ply 14 in the radial direction R, forms the third belt ply 15. That belt ply 17 which is arranged on the third belt ply 15, outside the third belt ply 15 in the radial direction R, forms the fourth belt ply 17.

The belt ply 14 and the belt ply 15 are formed as working plies of the tire and extend in each case in the circumferential direction U over the entire circumference of the pneumatic vehicle tire and in the axial direction A from the left-hand tire shoulder to the right-hand tire shoulder, wherein the belt plies are arranged so as to be in contact with one another at least in partial sections. The working ply 14 is formed from a ply of filiform parallel strength members 24 which are embedded in rubber and which extend substantially rectilinearly over the entire width b, measured in the axial direction A, of the belt ply 13 and which enclose an angle of inclination α with the circumferential direction U, where 10°≤α≤45°. In a particular embodiment, α is selected such that 15°≤α≤30°.

The working ply 15 is formed from a ply of filiform parallel strength members 25 which are embedded in rubber and which extend substantially rectilinearly over the entire axial width c of the belt ply 15 and which enclose an angle of inclination γ with the circumferential direction U, where 10°≤γ≤45°. In a particular embodiment, γ is selected such that 15°≤γ≤30°.

The direction of inclination of the strength members 25 of the working plies 15 as viewed along the circumferential direction U is oriented in the opposite axial direction A in relation to the direction of inclination of the strength members 24 of the working ply 14.

The first belt ply 13 formed within the second belt ply 14 in the radial direction R extends in the circumferential direction U over the entire circumference of the pneumatic vehicle tire and in the axial direction A from the left-hand tire shoulder to the right-hand tire shoulder, so as to be in contact with the belt ply 14 at least in partial sections. The belt ply 13 is formed from parallel filiform strength members 24 which are embedded in rubber and which extend substantially rectilinearly over the entire axial width a of the belt ply 13 and which enclose an angle of inclination β with the circumferential direction U, where 46°≤β≤<54°, for example where β=50°.

The fourth belt ply 17, arranged outside the third belt ply 15 in the radial direction R, extends in the circumferential direction U over the entire circumference of the pneumatic vehicle tire and in the axial direction A of the pneumatic vehicle tire from the left-hand tire shoulder to the right-hand tire shoulder, so as to be in contact with the belt ply 15 at least in partial sections. The belt ply 17 is formed from a ply of filiform parallel strength members 27 which are embedded in rubber and which extend substantially rectilinearly over the entire axial width h of the belt ply 17 and which enclose an angle of inclination ϵ with the circumferential direction U, where 46°≤ϵ≤54°, for example where ϵ=50°.

The strength members 27 of the fourth belt ply 17 are, in one embodiment, as illustrated in FIG. 2, oriented with the same axial direction of inclination, as viewed along the extent in the circumferential direction U of the tire, as the strength members 25 of the third belt ply 15 and as the strength members 23 of the first belt ply 13, and thus with an opposite axial direction of inclination in relation to the strength members 24 of the second belt ply 14.

Here, the inclination of the strength members 23, 25 and 27 with respect to the circumferential direction U is selected to have a rightward ascent, and the inclination of the strength members 24 with respect to the circumferential direction U is selected to have a leftward ascent. The inclination of the strength members with respect to the circumferential direction in the individual belt plies 13, 14, 15, 17, starting at the radially innermost belt ply 13, is thus such that the sequence LRLL is realized (leftward ascent, rightward ascent, leftward ascent, leftward ascent).

All four belt plies 13, 14, 15 and 17 extend to both axial sides, in each case as far as a position in the respective tire shoulder. The belt ply 17 is, at least over a part of its axial extent, in direct contact with the third belt ply (upper working ply) 15 arranged therebeneath.

The second belt ply (lower working ply) 14 extends in the axial direction A over an axial width b, the first belt ply 13 extends in the axial direction A over an axial width a, and the third belt ply (upper working ply) 15 extends in the axial direction A over an axial width c in the tire. The fourth belt ply 17 extends in the axial direction A over an axial width h in the tire. The extent widths a, c, b and h are in this case selected such that b>c>h and c>a. Here, the second belt ply 14 extends in both axial directions in each case by an axial extent length e beyond the axial position of the respective belt edge of the fourth belt ply 17. Likewise, the third belt ply 15 extends in both axial directions in each case by an axial extent length d beyond the axial position of the respective belt edge of the fourth belt ply 17. For the extent lengths e and d of this projecting length, the following applies: e>d. Here, the dimension d is configured to be d≥10 mm. In the embodiment, the dimension e is configured such that e≤80 mm.

Here, the first belt ply 13 extends to both axial sides of the fourth belt ply 17 by an axial extent length k beyond the axial position of the respective belt edge of the fourth belt ply 17.

The belt ply 13 extends over the axial extent of the second belt ply (radially inner working ply) 14 and ends in the axial direction A with its two belt ply edges in each case at an axial position between the axial position of the closest belt ply edge of the third belt ply (radially outer working ply) 15 and the axial position of the closest belt ply edge of the fourth belt ply 17, at an axial distance k from the belt ply edge of the fourth belt ply 17, where k<d<e and k≥0 mm.

In the embodiment illustrated, a>h and k>0 mm.

The strength members 23 and 27 are steel cords of known type, for example of “1+5” type, “3+6” type, “3+8” type or “3+9” type.

The strength members 24 and 25 of the two working plies 14 and 15 are extensible steel cords of known type which, under tensile load, exhibit a breaking force F of F>2500 N and, at 10% of the breaking force, an elongation D of D 0.2%—for example where 0.28%≤D≤0.32%. The elongation D of the strength members is in this case the elongation determined, in the case of the vulcanized tire, on the strength member extracted from the ply. The measurement of the elongation is performed on strength members which have been removed over their full length from the complete vulcanized tire. For the measurement, the strength member has rubber residues removed from it such that the strength member with the amount of rubber remaining thereon has a diameter no greater than 1.5 times the maximum outer diameter of the non-rubberized strength member. The determination of the elongation is performed in accordance with ASTM D 2969-04.

The strength members 24 and 25 are for example steel cords of “3+8×0.35HT” type, with a breaking force F of approximately 3000 N and with an elongation D of D>0.2% at 10% of the breaking force.

In one embodiment, the following values are selected: β=50°, α=18°, γ=18°, ϵ=50°, d=11 mm, k=8 mm and e=15 mm.

In the embodiments mentioned above in conjunction with FIGS. 1 to 2, the strength members 27 are steel cords. In another embodiment which is not illustrated, the strength members 27 are hybrid cords of known type which are suitable for use in utility vehicle tires, in the case of which filaments or threads are produced from different materials, such as for example steel, polyamide, glass fiber, polyester or aramid.

In another embodiment which is not illustrated, the strength members 23 and/or the strength members 24 and/or strength members 25 are also hybrid cords of known type which are suitable for use in utility vehicle tires, in the case of which filaments or threads are produced from different materials, such as for example steel, polyamide, glass fiber, polyester or aramid.

The angles α, β, γ, ϵ form in each case at least the angle of inclination of the respective strength member determined at the position of the equatorial plane Ä-Ä of the tire.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS

### Part of the Description

1 Bead region
2 Side wall
3 Crown region (head region)
4 Bead core
5 Carcass
6 Apex (bead filler)
7 Carcass turn-over
8 Bead reinforcing strip
9 Belt
10 Profiled tread
11 Side wall rubber strip
12 Inner layer
13 Belt ply (working ply)
14 Belt ply (zero-degree ply)
15 Belt ply (working ply)
16 Belt ply
17 Belt ply
23 Strength member
24 Strength member
25 Strength member
26 Strength member
27 Strength member

What is claimed is:

1. A pneumatic vehicle tire for utility vehicles, the pneumatic vehicle tire comprising:
a carcass;
the pneumatic vehicle tire defining a radial direction R and a circumferential direction U;
a belt constructed radially outside said carcass;
a profiled tread constructed on said belt radially outside said belt;
said belt being formed from at least four belt plies arranged lying one on top of the other from a radial inside to a radial outside,
said at least four belt plies include a first belt ply arranged furthest to the inside in the radial direction R, a second belt ply, a third belt ply and a fourth belt ply;
said first belt ply having a plurality of first parallel strength members embedded in rubber;
said second belt ply being arranged on said first belt ply and having a plurality of second parallel strength members embedded in rubber;
said third belt ply being arranged on said second belt ply and having a plurality of third parallel strength members embedded in rubber;
said fourth belt ply being arranged on said third belt ply and having a plurality of fourth parallel strength members embedded in rubber;
said second belt ply and said third belt ply being working plies in which said second strength members of said second belt ply enclose, in terms of their orientation, an angle α with the circumferential direction U, wherein 10°≤α≤45°, and said third strength members of said third belt ply each enclose, in terms of their orientation, an angle γ with the circumferential direction U, wherein 10°≤γ≤45°;
wherein said second strength members of said second belt ply, as viewed in the circumferential direction U of the vehicle tire, have an opposite axial direction of inclination in relation to said third strength members of said third belt ply;
said first strength members of said first belt ply enclose, in terms of their orientation, an angle β with the circumferential direction U, wherein 46°≤β≤54°;
said fourth strength members of said fourth belt ply enclose, in terms of their orientation, an angle ϵ with the circumferential direction U, wherein 46°≤ϵ≤54°; and,
said first strength members of said first belt ply and said third strength members of said third belt ply and said fourth strength members of said fourth belt ply are oriented in the tire with the same axial direction of inclination.

2. The pneumatic vehicle tire of claim 1, wherein said angle α with the circumferential direction U is configured such that 15°≤α≤30° and the angle γ with the circumferential direction U is such that 15°≤γ≤30°.

3. The pneumatic vehicle tire of claim 2, wherein said angle α with the circumferential direction U is 18°.

4. The pneumatic vehicle tire of claim 2, wherein said angle γ with the circumferential direction U is 18°.

5. The pneumatic vehicle tire of claim 1, wherein said angle β with the circumferential direction U is such that β=50°.

6. The pneumatic vehicle tire of claim 1, wherein the angle ϵ with the circumferential direction U is such that ϵ=50°.

7. The pneumatic vehicle tire of claim 1, wherein said first strength members, said second strength members, said third strength members and said fourth strength members each have a respective inclination with respect to the circumferential direction U such that a sequence LRLL from said first belt ply to said fourth belt ply results, wherein L means leftward ascent and R means rightward ascent.

8. The pneumatic vehicle tire of claim 1, wherein said first strength members, said second strength members, said third strength members and said fourth strength members are steel cords.

9. The pneumatic vehicle tire of claim 1, wherein said second belt ply is formed so as to be larger, in terms of its axial extent in the pneumatic vehicle tire, than all other belt plies of the belt.

10. The pneumatic vehicle tire of claim 1, wherein said third belt ply is formed so as to be larger, in terms of its axial extent in the pneumatic vehicle tire, than said first belt ply and said fourth belt ply.

11. The pneumatic vehicle tire of claim 1, wherein said second strength members and said third strength members are configured to be extensible with an elongation D of D≥0.2% at 10% of the breaking force.
